(19) United States
(12) Patent Application Publication
(10) Pub. No.: US 2014/0331325 A1
(43) Pub. Date: Nov. 6, 2014

(54) ANTI-MALWARE SYSTEM AND METHOD FOR PROCESSING DATA IN SYSTEM

(71) Applicant: SAMSUNG SDS CO., LTD., Seoul (KR)

(72) Inventor: In Seon Yoo, Osan-si (KR)

(21) Appl. No.: 14/361,702

(22) PCT Filed: Mar. 18, 2013
(86) PCT No.: PCT/KR2013/002187

§ 371 Date: May 30, 2014

Related U.S. Application Data
(60) Provisional application No. 61/613,641, filed on Mar. 21, 2012.

(51) Int. Cl. G06F 21/56

(52) U.S. Cl. CPC G06F 21/566
USPC 726/23

(57) ABSTRACT

Disclosed are an anti-malware system and a method for processing data in the system. The anti-malware system, according to one embodiment of the present invention, comprises: a host device which requests a malware detection scan on a file to be scanned; an anti-malware module which performs the malware detection scan on the file to be scanned, and which transmits the scan results to the host device, wherein a preprocessing for the malware detection scan of the file to be scanned is performed in the host device or the anti-malware module according to the size of the file to be scanned.

### 1. TECHNICAL FIELD

The present disclosure relates to technologies for detecting malicious code or malware from files.

### 2. BACKGROUND ART

Recently, smartphones, personal digital assistants (PDAs), tablets, and so on have been widely spread and become essentials for modern living. However, with the extension and enhancement of the hardware functions of mobile terminals, there is a growing concern that malicious code that has attacked computers would also have severe harmful effects on the mobile terminals. The malicious code may lead to malfunction of the mobile terminals and also cause critical damage such as data erasure or personal information leakage. Accordingly, there is a need for a solution to effectively protect the mobile terminals from various types of malicious code.

The conventional anti-malware solutions applied to mobile terminals are based on software. That is, for the purpose of malware detection, anti-malware software is installed, as an application, in mobile terminals. However, mobile devices have relatively strict limitations on resources such as a central processing unit, a battery, and so on. Thus, the use of such an existing solution would cause performance degradation such that it is inconvenient for a user to perform tasks other than the malware detection. Accordingly, in order to solve the above problem, a malware detection module has been introduced which is equipped with a mobile terminal in a form of system-on-chip in which hardware logic and firmware for a malware detection scan are configured as a chip.

Since a malware detection module in the form of system-on-chip does not consume hardware resources of a host device during a malware detection process, it is advantageous in that it does not affect the performance of the host device. However, even in this case, the hardware resources of the malware detection module have limited capacities, as compared to the host device. Thus, since a file may have a great capacity or a large amount of files may be released subsequent to decompression of a compressed file, the malware detection module needs to efficiently use restrictively allocated hardware resources. Accordingly, for the purpose of improvements in efficiency of malware scanning by high-speed hardware logic, there is a need for a technology of properly sharing responsibility between the host device and the malware detection module so that malware detection may be efficiently performed.

### 3. TECHNICAL PROBLEM

The present disclosure is directed to providing means by which a preprocessing process for malware detection can be distributed between the host device and the malware detection module, thereby enhancing file scanning performance for malware detection.

### 4. TECHNICAL SOLUTION

According to an exemplary embodiment of the present disclosure, there is provided an anti-malware system including: a host device configured to request a malware detection scan on a scan target file; and an anti-malware module configured to perform the malware detection scan on the scan target file according to the request by the host device and transmit a result of the scan to the host device, wherein preprocessing for the malware detection scan on the scan target file is performed in the host device or the anti-malware module according to a size of the scan target file.

According to another exemplary embodiment of the present disclosure, there is provided a method of processing data in an anti-malware system, the method including: determining, by a host device, a preprocessing position for a malware detection scan of a scan target file according to a size of the scan target file; preprocessing, by the host device or the anti-malware module, the scan target file; and performing, by the anti-malware module, a malware detection scan on the preprocessed scan target file to transmit a result of the scan to the host device.

According to still another exemplary embodiment of the present disclosure, there is provided an anti-malware system including: an API configured to receive a scan request from an application and request a malware detection scan on a scan target file according to the scan request; an application configured to request a scan of a file stored in the host device through the API; and an anti-malware module configured to perform the malware detection scan on the scan target file from the API and transmit a result of the scan to the host device, wherein preprocessing for the malware detection scan on the scan target file is performed in the host device or the anti-malware module according to a size of the scan target file.

### ADVANTAGEOUS EFFECTS

According to embodiments of the present disclosure, it is possible to enhance file scanning performance for malware detection by distributing and performing a preprocessing process for malware detection between the host device and the malware detection module.

Furthermore, it is also possible to minimize the load of the host device by maximizing an operating ratio of the anti-malware module during a preprocessing process for malware detection.

### DESCRIPTION OF DRAWINGS

FIG. 1 is a block diagram illustrating a configuration of an anti-malware system according to an embodiment of the present disclosure.

FIG. 2 is a block diagram illustrating details of a host device according to an embodiment of the present disclosure.

FIG. 3 is a view illustrating a file transfer order in a host device according to an embodiment of the present disclosure.

FIG. 4 is a block diagram illustrating details of an anti-malware module according to an embodiment of the present disclosure.

FIG. 5 is a flowchart illustrating a malware scanning method in an anti-malware system according to an embodiment of the present disclosure.

FIG. 6 is a flowchart illustrating a malware scanning method in an anti-malware system according to another embodiment of the present disclosure.

FIG. 7 is a flowchart illustrating a malware scanning method in an anti-malware system according to still another embodiment of the present disclosure.

### MODES OF THE INVENTION

Hereinafter, embodiments of the present disclosure will be described in detail with reference to the accompanying drawings. However, the embodiments are only exemplary and the present disclosure is not limited thereto.

In describing the present disclosure, a detailed description of known techniques associated with the present disclosure that is determined to unnecessarily obscure the gist of the present disclosure, will be omitted. Also, the terms described below are defined in consideration of the functions in the present disclosure, and thus may vary depending on a user, intention of an operator, or custom. Accordingly, the definition should be made on the basis of the whole specification.

The technical scope of the present disclosure is defined by the claims, and the following embodiments are intended only to explain the technical scope of the present disclosure to those skilled in the art.

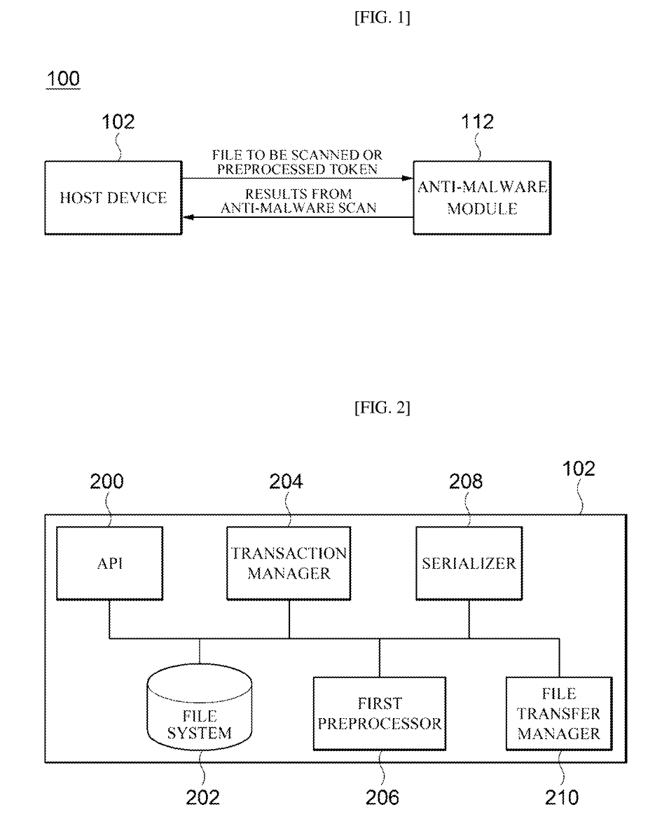

FIG. 1 is a block diagram illustrating a configuration of an anti-malware system 100 according to an embodiment of the present disclosure. The anti-malware system 100 according to an embodiment of the present disclosure is a system for detecting whether there is malware such as a virus, malicious code, etc. in files stored in a file system. As shown in FIG. 1, the anti-malware system 100 according to an embodiment of the present disclosure includes a host device 102 and an anti-malware module 104.

The host device 102 is a device having a file for malware detection (that is, a file to be scanned; hereinafter also referred to as a scan target file) stored therein, which requests the anti-malware module 104 to perform a malware scan on the scan target file, receives a result of the malware scan from the anti-malware module 104, and outputs the result. According to an embodiment of the present disclosure, the host device 102 may be a desktop computer, a mobile device such as a smartphone or tablet, an embedded device, or the like.

The host device 102 may include hardware elements for performing general functions of a computer, for example, a central processing unit (CPU) and a memory. In addition, the host device 102 may include a separate operating system for driving the hardware elements and anti-malware software driven on the operating system, and the anti-malware software is configured to provide malware scanning and detection service to a user of the host device 102 using the anti-malware module 104 to be described below.

The anti-malware module 104 receives an anti-malware scan request from the host device 102, performs a malware detection scan on the scan target file provided from the host device 102, and transmits a result of the scan to the host device 102. According to an embodiment of the present disclosure, the anti-malware module 104 may be configured as a system-on-chip (SoC) and the host device 102 may be equipped therewith. A system-on-chip is configured as a single chip including hardware logic and firmware for a malware detection scan. However, the present disclosure is not limited thereto, and the anti-malware module 104 may be configured as separate hardware that is connected with the host device 102.

The anti-malware module 104 may require a memory region for storing and processing a scan target file provided from the host device 102. To this end, the anti-malware module 104 may be configured to have its own memory or use a designated portion of the memory region of the host device 102. However, in all cases, an available memory capacity of the anti-malware module 104 is generally less than that of the host device 102.

For the malware detection scan of the anti-malware module 104, above all, preprocessing of the scan target file is needed. The preprocessing of the scan target file means a process of decompressing the scan target file (if the file is compressed), parsing the decompressed file by a unit size to enable a one-time scan, and generating tokens. According to an embodiment of the present disclosure, the preprocessing of the scan target file may be performed by any one of the host device 102 and the anti-malware module 104 depending on the size of the scan target file. That is, the host device 102 may be configured to determine whether to perform the preprocessing in the host device 120 or the anti-malware module 104 depending on the size of the scan target file.

For example, when the scan target file is so small that the file may be sufficiently preprocessed using the memory capacity of the anti-malware module 104, the host device 102 may transmit the scan target file without any processing, and the anti-malware module 104 may concurrently perform preprocessing and malware detection scan on the received scan target file. Unlike this, when the size of the scan target file is greater than a processible capacity (reference value) of the anti-malware module 104, the host device 102 may autonomously preprocess the scan target file and transmit a token, which is generated through the preprocessing, to the anti-malware module 104. As such, according to embodiments of the present disclosure, it is possible to maximize an operating rate of the anti-malware module 104 and enhance a processing performance on the scan target file by appropriately distributing a preprocessing position of a file depending on the capacity of the scan target file.

FIG. 2 is a block diagram illustrating details of a host device 102 according to an embodiment of the present disclosure.

As shown in FIG. 2, the host device 102 according to an embodiment of the present disclosure may include an Application Programming Interface (API) 200, a file system 202, a transaction manager 204, a first preprocessor 206, a serializer 208, and a file transfer manager 210.

The API 200 provides an interface for receiving information on selection of the scan target file and providing a result of the malware detection scan on the selected file. In other words, the API 200 is an interface for connecting with various security applications using the anti-malware module, through which an input and an output may be performed between the anti-malware module and various security applications.

The file system 202 is a space for storing files. The file system 202 may include data storage means such as a non-volatile memory, a magnetic disk, or the like and have a data storage structure appropriate for storage and management of the file. It is possible to select some or all of files stored in the file system 202 through the API 200 and request a malware detection scan on the selected file.

The transaction manager 204 controls a malware detection scan process for the scan target file, which is requested through the API 200. First, the transaction manager 204 generates a transaction for each scan target file, which is requested through the API 200. The transaction is a processing unit for each scan target file, which is used by the transaction manager 204. The generated transaction may end after completion of the processing thereof (transaction commit) or may be rolled back.

Conditions for committing or rolling back the transaction generated by the transaction manager 204 are as follows. First, when a result of the malware detection scan is received from the anti-malware module 104, the transaction manager 204 notifies the API 200 of the scan result (clean or malware detection) and commits the transaction. In addition, when the transaction manager 204 receives a message to disable preprocessing of the file transferred to the anti-malware module 104, the transaction manager 204 rolls back the transaction, which will be described below.

When the transaction is generated, the transaction manager 204 determines a preprocessing position of the scan target file. As described above, when a size of the scan target file is greater than a predetermined reference value, the transaction manager 204 determines that the preprocessing of the scan target file will be performed in the host device 102 and requests a first preprocessor 206 to preprocess the scan target file. Unlike this, when the size of the scan target file is equal to or less than the reference value, the transaction manager 204 requests the file transfer manager 210 to transmit the scan target file.

The first preprocessor 206 preprocesses the scan target file according to a preprocessing request from the transaction manager 204. Specifically, the first preprocessor 206 is configured to parse the scan target file, by a predetermined size, to generate a plurality of tokens. In this case, the size of each token, that is, each piece of the scan target file, may be appropriately determined in consideration of data capacity that can be processed at one time by the anti-malware module 104.

If the scan target file is a compressed file, the first preprocessor 206 decompresses the scan target file, parses the decompressed file, and generate tokens. That is, according to an embodiment of the present disclosure, the first preprocessor 206 generate tokens for a file that is generated by decompressing the compressed file in addition to tokens for the compressed file. That is, in an embodiment of the present disclosure, the malware detection is performed on the compressed scan target file in addition to the decompressed scan target file. In addition, the first preprocessor 206 generate tokens for the decompressed file or transmits the decompressed file to the anti-malware module 104 depending on the size of the decompressed file.

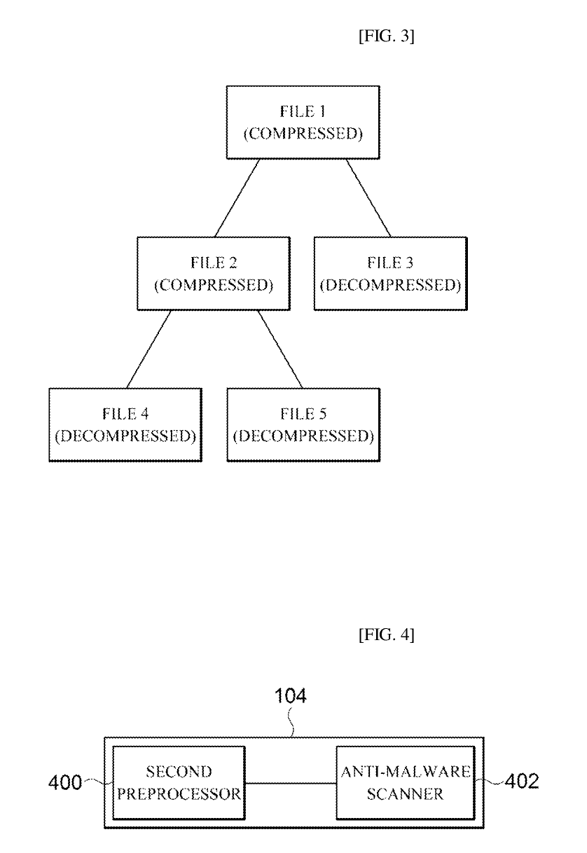

For example, this may be described as shown in FIG. 3. It is assumed that the scan target file (file 1) is obtained by compressing file 2 and file 3, and file 2 is obtained by compressing file 4 and file 5. In this case, the files may be represented in a tree structure as shown in FIG. 3. If the first preprocessor 206 sequentially processes files included in the tree structure, for example, in a preorder traverse manner, the first preprocessor 206 may preprocess the files in the following order:

File 1->File 2->File 4->File 5->File 3.

As described above, the first preprocessor 206 may be configured to parse the files to generate tokens, or transmit the file itself to the anti-malware module 104 in consideration of the capacity of each file. For example, when the size of file 4 is greater than the predetermined reference capacity, the parsing of file 4 may be performed by the first preprocessor 206, and when the size of file 5 is equal to or less than the predetermined reference capacity, the parsing of file 5 may be performed by the anti-malware module 104.

However, when the tokens for the scan target file are generated as described above, the transaction manager 204 may generate a sub-transaction for each token. In this case, all sub-transactions generated from the same scan target file may form a transaction group. Each sub-transaction included in the transaction group may be committed as a result of the malware detection, by the anti-malware module 104, for the corresponding tokens. A transaction corresponding to the scan target file is committed when the sub-transaction included in the transaction group is committed. If malware is detected in even one of the sub-transactions included in the transaction group, it is determined that the scan target file has the malware. If it is determined that there is no malware in any of the sub-transactions, it is determined that the scan target file has no malware.

The serializer 208 serializes a plurality of tokens generated by the first preprocessor 206. Serialization means a task of determining a transfer order of the tokens in consideration of positions of the generated tokens in the file and adding attributes appropriate for the malware detection to each token. The attribute may include, for example, a serial number of a token, a hash value of an original file, etc. However, details thereof are excluded from the scope of the present disclosure, and thus detailed description thereof will be omitted.

The file transfer manager 210 transmits a token serialized by the serializer 208 and a file requested from the transaction manager 204 or the first preprocessor 206 to the anti-malware module 104.

In an embodiment, the file transfer manager 210 may further include a file transfer queue for temporarily storing a token or file that is requested to be transferred. In this case, when the size of the token or file stored in the file transfer queue is less than a transfer reference capacity, the file transfer manager 210 may merge two or more tokens or files in the range not exceeding the transfer reference capacity and transmit the merged tokes or files to the anti-malware module 104. In addition, conversely, when the size of the token or file stored in the file transfer queue is greater than the transfer reference capacity, the file transfer manager 210 may divide the token or file into a plurality of blocks and transmit the blocks to the anti-malware module 104.

When the file transfer manager 210 does not include the file transfer queue, the file transfer manager 210 transmits the received files to the anti-malware module 104 without storing the files separately.

FIG. 4 is a block diagram illustrating details of an anti-malware module 104 according to an embodiment of the present disclosure. As shown in FIG. 4, the anti-malware module 104 according to an embodiment of the present disclosure includes a second preprocessor 400 and anti-malware scanner 402.

The second preprocessor 400 parses a file received from the file transfer manager 210 by a predetermined size to generate a plurality of tokens. If the received file is a compressed file, the second preprocessor 400 decompresses the compressed file and then parses the decompressed file to generate tokens. That is, in an embodiment of the present disclosure, the second preprocessor 400 basically performs the same function as the preprocessor 206 included in the host device 102.

As a result of the decompression of the second preprocessor 400, if the size of the decompressed file is greater than the reference value, the second preprocessor 400 requests the transaction manager 204 to roll back the preprocessing of the received file. That is, when it is determined that the processing is not possible using a memory capacity of the anti-malware module 104 because the size of the decompressed file is excessively greater than the size of the compressed file, the second preprocessor 400 requests the transaction manager 204 to perform the preprocessing thereof at the host device 102 side. When the request is received, the transaction manager 204 controls the first preprocessor 206, the serializer 208, and the file transfer manager 210 to preprocess the file, and then retransmit the generated token to the anti-malware module 104.

The anti-malware scanner 402 performs a malware detection scan on the token received from the file transfer manager 210 or the token generated by the second preprocessor 400 and transmits a result of the scan to the transaction manager 204.

When the anti-malware module 104 is configured as a system-on-chip (SoC) as shown in FIG. 4, the first preprocessor 206 of the host device 102 may preprocess other files during operation of the second preprocessor 400 and the anti-malware scanner 402. That is, the host device 102 and the anti-malware module 104 may preprocess each of the scan target files in parallel, thereby enhancing overall efficiency of the malware detection scanning process.

In addition, when the anti-malware module 104 is configured not as a system-on-chip but as separate hardware connected with the host device 102, the anti-malware module 104 may be configured to include only the anti-malware scanner 402. That is, in this case, the preprocessing of all scan target files is performed in the host device 102, and only the anti-malware scanner 402 is operated in the anti-malware module 10. Accordingly, the anti-malware scanner 402 performs a malware detection scan on the token received from the file transfer manager 210 and transmits a result of the scan to the transaction manager 204.

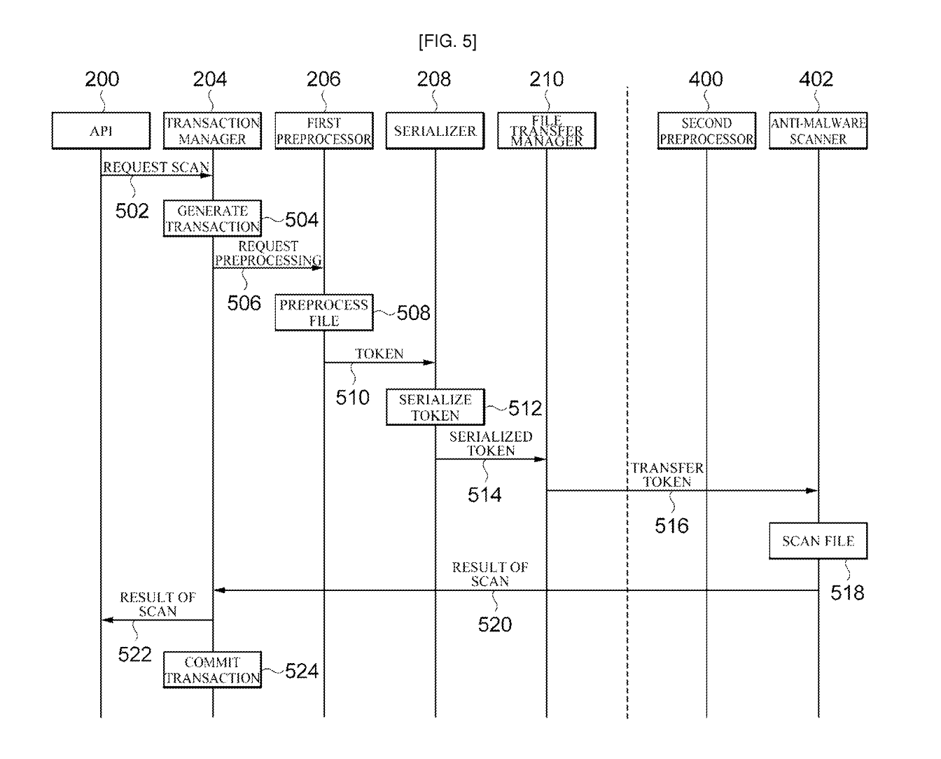

FIGS. 5 to 7 are flowcharts illustrating a malware scanning method in an anti-malware system according to embodiments of the present disclosure.

FIG. 5 is a flowchart for illustrating a case in which the preprocessing of the scan target file is achieved by the first preprocessor 206 in the host device 102. That is, this embodiment illustrates an anti-malware scanning process when the size of the scan target file is greater than a predetermined reference value.

When a malware scan request is received from the API 200 in operation 502, the transaction manager 204 generates a transaction for a requested scan target file in operation 504 and requests to preprocess the scan target file in operation 506.

Subsequently, the first preprocessor 206 preprocesses the scan target file requested from the transaction manager 204 in operation 508. Since the preprocessing process of the first preprocessor 206 has been described, detailed description thereof will be omitted. The serializer 208 receives tokens generated as a result of the preprocessing of the first preprocessor 206 and serializes the generated tokens in operations 510 and 512. Then the file transfer manager 210 receives the serialized tokens and transmits the received tokens to the anti-malware scanner 402 of the anti-malware module 104.

The anti-malware scanner 402 performs a malware detection scan for each of the received tokens in operation 518 and transmits a result of the scan to the transaction manager 204. Then the transaction manager 204 outputs the received scan result through the API 200 in operation 522, and commits the generated transaction in operation 524.

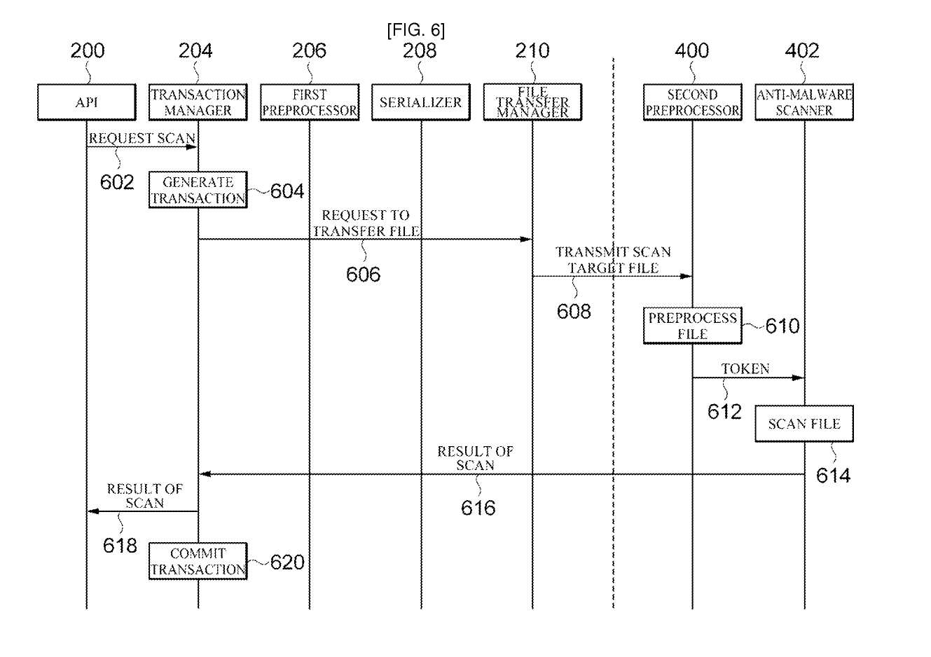

FIG. 6 is a flowchart for illustrating a case in which the preprocessing of the scan target file is achieved by the second preprocessor 400 in the anti-malware module 104. That is, this embodiment illustrates an anti-malware scanning process when the size of the scan target file is equal to or less than a predetermined reference value.

When a malware scan request is received from the API 200 in operation 602, the transaction manager 204 generates a transaction for a requested scan target file in operation 604, and requests transfer of the scan target file in operation 606. Then the file transfer manager 210 transfers the scan target file to the second preprocessor 400 in operation 608.

Subsequently, the second preprocessor 400 preprocesses the scan target file received from the file transfer manager 210 in operation 610, and the anti-malware scanner 402 receives tokens generated as a result of the preprocessing in operation 612, performs a malware detection scan for each of the received tokens in operation 614, and transfers a result of the scan to the transaction manager 204. Then the transaction manager 204 outputs the received scan result through the API 200 in operation 618, and commits the generated transaction in operation 620.

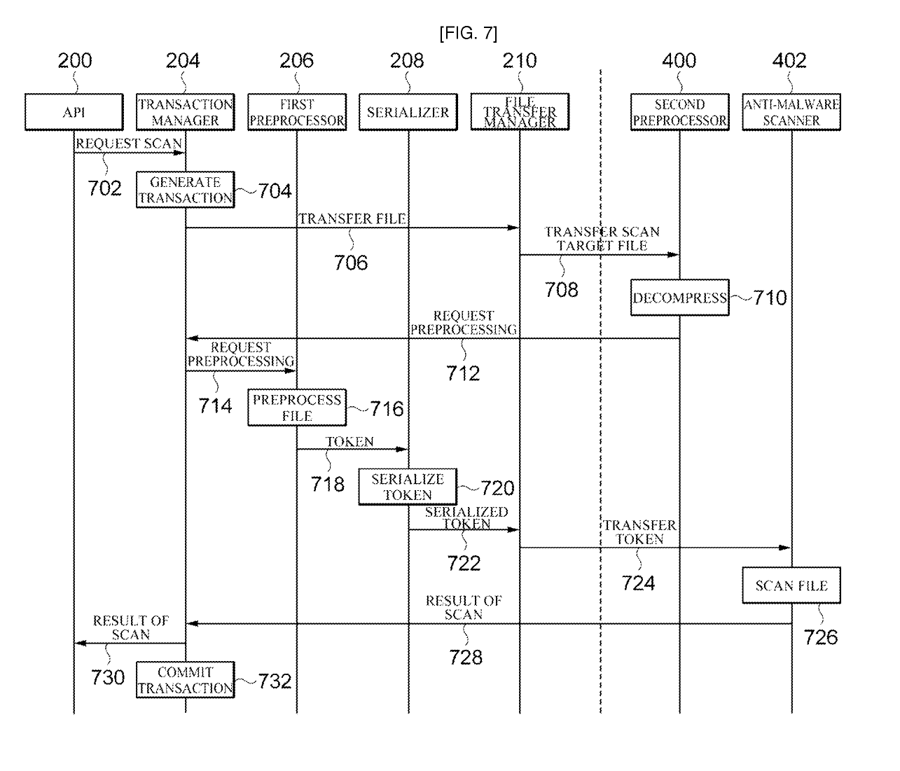

FIG. 7 is a flowchart for illustrating a case in which the second preprocessor 400 in the anti-malware module 104 requests the host device 102 to roll back preprocessing of the scan target file while preprocessing the scan target file. That is, this embodiment illustrates a scanning process when the size of the compressed scan target file is less than a predetermined reference value, and the size of the decompressed scan target file is greater than the predetermined reference value.

When a malware scan request is received from the API 200 in operation 702, the transaction manager 204 generates a transaction for a requested scan target file in operation 704, and requests transfer of the scan target file in operation 706. Then the file transfer manager 210 transfers the scan target file to the second preprocessor 400 in operation 708.

Subsequently, the second preprocessor 400 decompresses the received file in order to preprocess the scan target file received from the file transfer manager 210 in operation 610. Then, when the size of the file decompressed as a result of operation 610 is greater than a predetermined reference value, the second preprocessor 400 requests the transaction manager 204 to roll back preprocessing of the file in operation 712, and the transaction manager 204 requests the first preprocessor 206 to preprocess the requested file in operations 714.

Subsequently, the first preprocessor 206 preprocesses the scan target file requested from the transaction manager 204 in operation 716. Next, the serializer 208 receives tokens generated as a result of the preprocessing of the first preprocessor 206 and serializes the generated tokens in operations 718 and 720. Subsequently, the file transfer manager 210 receives the serialized tokens and transmits the received tokens to the anti-malware scanner 402 of the anti-malware module 104.

The anti-malware scanner 402 performs a malware detection scan for each of the received tokens in operation 726 and transmits a result of the scan to the transaction manager 204. Then the transaction manager 204 outputs the received scan result through the API 200 in operation 730, and commits the generated transaction in operation 732.

Meanwhile, exemplary embodiments of the present disclosure may include a computer-readable recording medium including a program for performing the methods described in the present specification in a computer. The computer-readable recording medium may include program instructions, local data files, and local data structures, alone or in combination. The medium may be specially designed and configured for the present disclosure, or well known and available to those skilled in the field of computer software. Examples of the computer-readable recording medium include magnetic media such as a hard disk, a floppy disk and a magnetic tape, optical recording media such as a CD-ROM and a DVD, a magneto-optical medium such as a floptical disk, and hardware devices, specially configured to store and execute program instructions, such as a ROM, a RAM, and a flash memory. Examples of the program instructions may include high-level language codes executable by a computer using an interpreter or the like, as well as machine language codes made by a compiler.

Although the disclosure has been described with reference to specific embodiments, it will be understood by those skilled in the art that various changes may be made without departing from the spirit or scope of the disclosure.

Thus, it is intended that the present disclosure covers all such modifications provided they come within the scope of the appended claims and their equivalents.

1. An anti-malware system comprising:
a host device configured to generate a malware detection scan request with respect to a scan target file, and to perform a preprocessing operation for the malware detection scan; and
an anti-malware module configured to perform the preprocessing operation, perform the malware detection scan on the scan target file in response to the malware detection scan request, and transmit a result of the scan to the host device,
wherein a determination, as to which of at least one of the host device and the anti-malware module is used to perform the preprocessing operation, is made according to a size of the scan target file.

2. The anti-malware system of claim 1, wherein the host device makes the determination.

3. The anti-malware system of claim 2, wherein:
the host device is further configured to make the determination based on a comparison of the size of the scan target file to a reference value;
when the host device detects that the size exceeds the reference value, the determination is that the host device performs the preprocessing operation;
the host device is further configured to perform the preprocessing operation so as to obtain a preprocessed scan target file; and
the host device is further configured to output the preprocessed scan target file to the anti-malware module.

4. The anti-malware system of claim 1, wherein the preprocessing operation is performed in parallel on the host device and the anti-malware module.

5. The anti-malware system of claim 1, wherein the host device comprises:
a transaction manager configured to determine, according to the size of the scan target file, whether the scan target file is to be preprocessed, and to generate a corresponding preprocessing request;
a first preprocessor configured to preprocess the scan target file in response to the preprocessing request to generate a plurality of tokens;
a serializer configured to serialize the plurality of tokens; and
a file transfer manager configured to output, to the anti-malware module, an output item including at least one of:
the tokens serialized by the serializer, and
a file indicated by the transaction manager.

6. The anti-malware system of claim 5, wherein:
when the size of the scan target file is greater than a reference value, the transaction manager requests the first preprocessor to preprocess the scan target file; and
when the size of the scan target file is not greater than the reference value, the transaction manager requests the file transfer manager to output the scan target file to the anti-malware module.

7. The anti-malware system of claim 5, wherein the first preprocessor parses the scan target file by a predetermined size to generate the plurality of tokens.

8. The anti-malware system of claim 7, wherein:
when the scan target file is a compressed file, the first preprocessor decompresses the scan target file; and
when a size of the decompressed file is greater than a reference value, the first preprocessor parses the decompressed file to generate the plurality of tokens.

9. The anti-malware system of claim 8, wherein the serializer serializes the plurality of tokens generated by the first preprocessor to produce serialized tokens for outputting to the anti-malware module.

10. The anti-malware system of claim 5, wherein the file transfer manager further comprises a file transfer queue configured to store the output item.

11. The anti-malware system of claim 10, wherein, when a size of the output item stored in the file transfer queue is less than a reference transfer capacity, the file transfer manager merges two or more output items so as to remain within the reference transfer capacity, and outputs the merged output items to the anti-malware module.

12. The anti-malware system of claim 11, wherein, when the size of the output item stored in the file transfer queue is greater than a reference transfer capacity, the file transfer manager divides the output item into a plurality of blocks and outputs the plurality of blocks to the anti-malware module.

13. The anti-malware system of claim 5, wherein the anti-malware module comprises:
a second preprocessor configured to parse the file received from the file transfer manager, by a predetermined size, to generate the plurality of tokens; and
an anti-malware scanner configured to perform a malware detection scan on the plurality of tokens received from the file transfer manager and the tokens generated by the second preprocessor and provide a result of the scan to the transaction manager.

14. The anti-malware system of claim 13, wherein:
when the received file is a compressed file, the second preprocessor decompresses the scan target file; and
when a size of the decompressed file is greater than a reference value, the second preprocessor requests the transaction manger to roll back the preprocessing of the received file.

15. A method of processing data in an anti-malware system, the method comprising:
determining, by a host device, a preprocessing disposition for a malware detection scan on a scan target file, based on a size of the scan target file;
preprocessing the scan target file using at least one of the host device and an anti-malware module, depending on the preprocessing disposition, to provide a preprocessed scan target file; and
performing, by the anti-malware module, a malware detection scan on the preprocessed scan target file to output a result of the scan to the host device.

16. The method of claim 15, wherein the determining of the preprocessing disposition comprises determining which of at least one of the host device and the anti-malware module is used to perform the preprocessing operation, according to the size of the scan target file.

17. The method of claim 16, wherein when the size of the scan target file is greater than a reference value, the preprocessing comprises:
performing, by the host device, a first preprocessing operation of preprocessing the scan target file; and
outputting, by the host device, the preprocessed scan target file to the anti-malware module.

18. The method of claim 17, wherein the first preprocessing operation comprises:
parsing the scan target file, by a predetermined size, to generate a plurality of tokens; and
serializing the generated plurality of tokens.

19. The method of claim 18, wherein the first preprocessing operation further comprises:
decompressing the scan target file to produce a decompressed file, when the scan target file is a compressed file; and
parsing the decompressed file to generate the plurality of tokens when a size of the decompressed file is greater than a reference value.

20. The method of claim 19, wherein:
the serializing comprises serializing the plurality of tokens generated from one or more of the scan target file, the decompressed file, and the tokens generated from the decompressed file; and
the plurality of tokens thus serialized are output to the anti-malware module.

21. The method of claim 15, wherein when the size of the scan target file is equal to or less than a reference value, the preprocessing further comprises:
receiving, by the anti-malware module, a file from the host device; and
performing, by the anti-malware module, a second preprocessing operation including parsing the received file by a predetermined size to generate a plurality of tokens.

22. The method of claim 21, wherein, when the received file is a compressed file, the second preprocessing operation comprises decompressing the scan target file.

23. The method of claim 22, wherein, when the decompressed file has a respective size greater than a reference value, the second preprocessing operation further comprises requesting the host device to roll back the preprocessing of the received file.

24. An anti-malware system comprising:
an API configured to receive a scan request and request a malware detection scan on a scan target file indicated by the scan request;
an application configured to generate the scan request, to request via the API a malware detection scan of a file stored in the host device through the API, the scan target file corresponding to the file stored in the host device; and
an anti-malware module configured to perform the malware detection scan on the scan target file in response to the scan request received via the API and output a result of the scan to the host device,
wherein a preprocessing operation for the malware detection scan on the scan target file is performed in at least one of the host device and the anti-malware module based on a size of the scan target file.

25. The anti-malware system of claim 24, wherein the host device comprises a transaction manager configured to make a determination, as to which of at least one of the host device and the anti-malware module is used to perform the preprocessing operation.

26. The anti-malware system of claim 25, wherein the host device further comprises a preprocessor configured to perform the preprocessing operation with respect to the scan target file in response to a preprocessing request from the transaction manager, and to generate a plurality of tokens as a result of the preprocessing operation.

27. The anti-malware system of claim 26, wherein the host device further comprises a serializer configured to serialize the plurality of tokens generated by the preprocessor and provide a plurality of serialized tokens.

28. The anti-malware system of claim 27, wherein the host device further comprises a file transfer manager configured to output, to the anti-malware module, the plurality of serialized tokens.
